(19) United States
(12) Patent Application Publication
(10) Pub. No.: US 2013/0031301 A1
(43) Pub. Date: Jan. 31, 2013

(54) BACKEND ORGANIZATION OF STORED DATA

(71) Applicant: Richard D. BARNDT, San Diego, CA (US)

(72) Inventor: Richard D. BARNDT, San Diego, CA (US)

(73) Assignee: STEC, Inc., Santa Ana, CA (US)

(21) Appl. No.: 13/559,535

(22) Filed: Jul. 26, 2012

Related U.S. Application Data
(60) Provisional application No. 61/513,486, filed on Jul. 29, 2011.

(51) Int. Cl. G06F 12/02

(52) U.S. Cl. 711/103; 711/E12.008

(57) ABSTRACT

A data units received from a host system are divided and/or redistributed among a plurality of data payloads, wherein boundaries of the data units are not aligned with boundaries of the data payloads. The plurality of data payloads are encoded into a respective plurality of codewords, and the plurality of codewords stored in the flash memory. Boundaries of the codewords are aligned with boundaries of the pages in the flash memory.

### CROSS-REFERENCES TO RELATED APPLICATIONS

This application claims priority from U.S. Provisional Application No. 61/513,486, entitled “Backend Mapped ECC,” and filed Jul. 29, 2011, which is incorporated herein by reference in its entirety.

### BACKGROUND

The subject technology generally relates to solid-state storage devices. A conventional method for reliably storing data in a data storage medium such as flash memory has been to encode each unit of host data (for example, a sector of data) into an error-correcting code (ECC) codeword. Each sector is then retrieved from the media and ECC decoded before passing the error free data back to the user. The size of a sector of host data can vary somewhat depending on the host system. That is the host sector size can be much larger or smaller than a codeword. For example, in enterprise applications, sector size may be 536 bytes before adding ECC compared to 512 bytes used in many consumer applications. Even though these extra few bytes are not a large percentage of the data they may add a great deal of complexity to, and compromise the performance of, a flash memory based storage system like a solid-state drive.

### SUMMARY

A system and method for storing data in a solid-state device is disclosed. According to one aspect, a method may include receiving a plurality of host data units for storage in solid-state device (for example, a flash memory) comprising a plurality of pages, dividing the plurality of host data units among a plurality of data payloads, wherein boundaries of the host data units are not aligned with boundaries of the data payloads, encoding the plurality of data payloads into a respective plurality of codewords, and storing the plurality of codewords in the flash memory, wherein boundaries of the codewords are substantially aligned with boundaries of the pages in the flash memory. In another aspect, a machine-readable media may include instructions thereon that, when executed, perform the previously described method.

In a further aspect, a system may include one or more memory units, one or more data buffers configured to receive, for storage in a flash memory, host data units from a host computing system, and a controller. The controller may be configured to divide a plurality of received host data units among a plurality of data payloads, wherein boundaries of the host data units are not aligned with boundaries of the data payloads, facilitate encoding the plurality of data payloads into a respective plurality of codewords, and store the plurality of codewords in the flash memory, wherein boundaries of the codewords are substantially aligned with boundaries of pages in the flash memory.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1A depicts a block diagram illustrating an example series of codewords, including host data and error correction coding, stored across multiple pages of a memory block.

FIG. 1B depicts a block diagram illustrating an example series of codewords and an unused section stored on one page of a flash memory device.

FIG. 2 depicts an example system for mapping data sectors received from a host system to codewords sized for storage on a disparate storage device.

FIG. 3 is a flowchart illustrating an example process for storing data in a flash memory device.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

Flash memory is organized into blocks of flash memory cells. Each block includes a number of pages that may contain thousands of bits. Blocks of flash memory must be erased as a unit, but the pages in the block may be sequentially programmed with data in a well defined sequence. Reading may be performed on a page basis inside the flash memory chip. All the bits in the page may be read in parallel, but the time to read a page may be large compared with the time it takes to process the data and return it to the host.

Some manufacturers of flash memory devices may produce flash memory pages that are sized to hold multiples of 512 bytes plus some extra space for the expected error-correcting code (ECC) overhead. However, this layout may not be suitable for applications that use sectors of different sizes (for example, enterprise applications may use 528 byte or 536 byte sectors plus ECC). When writing host sectors larger than 512 bytes in a solid state drive (SSD) that is configured for 512 byte host sectors, the SSD may have to either stop short of filling a whole page in flash memory because undivided codewords will not fill the page, or split some of the codewords across two pages. The former may be expensive because more flash memory is required to store the same amount of host data. The latter may require reading two pages to retrieve the codeword(s) for a single host sector, which ties up resources in the SSD while waiting to retrieve both pages.

ECC decoding cannot be started until the whole ECC codeword has been retrieved from the flash memory. If an ECC codeword is split between two flash pages the decoder must wait for both pages to be read, which could require holding the first received portion in a buffer for quite a long time (relative to the processor clock speed) until the second portion is received. For more advance ECC systems such as (low-density parity check) LDPC the consequences may be more severe because the error characteristics of the two pages may require different handling.

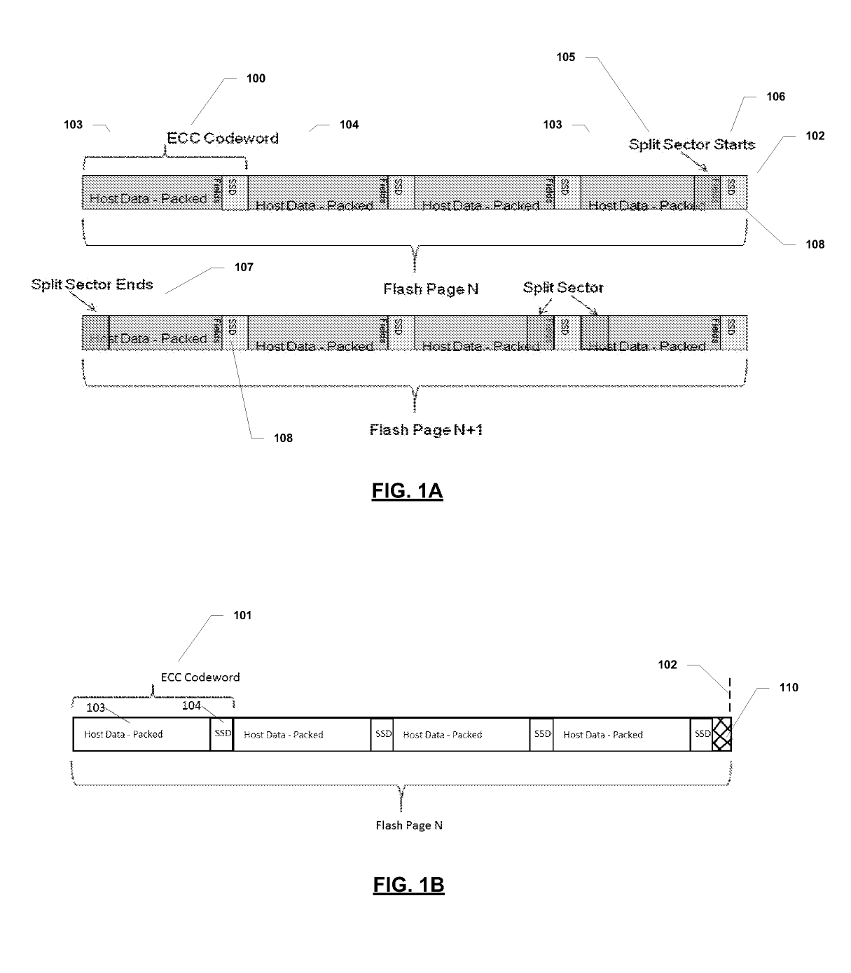

FIG. 1A depicts a block diagram illustrating an example series of codewords, including host data and error correction coding, stored across multiple pages of a memory block according to one aspect of the subject technology. The subject technology generates and provides ECC codewords 101A that, when written to a flash memory page, do not cross a memory page boundary 102, yet still utilize all of the available storage capacity of a flash memory. Each codeword 100 may include a portion of host sector data or data payload 103 and corresponding error correction data 104 (for example, provided by the SSD). In one aspect, the code is selected such that the length of each codeword 100 is a divisor of the flash page size (or very slightly smaller than some divisor). In this manner, codewords may start at precise offsets from the address of the beginning of a flash memory page. The codeword domain, or “back end,” of the SSD—the portion of the electronics that interfaces with the flash memory—may read and write data in a different way than what may be expected based on the size of sectors received from a host. For example, a single host sector received from a host system, once received at the back end, may not fall entirely within a single ECC codeword, may cross codeword boundaries, or may even cross flash page boundaries. Accordingly, prior to storage of received host data sectors, the subject technology divides the host sectors among one or more codewords sized to fit neatly within the boundaries of a flash page. In this respect, the front end, or logical domain, of the SSD system is separated from the back end, and the hardware comprising each domain is allowed to function autonomously.

As depicted by FIG. 1A, a host sector may be split between a flash page N and flash page N+1. In the depicted example, a first codeword 105 includes one (complete) host sector data 103 and a portion of a split host sector data 106 (for example, a sector that cannot fit into a single codeword 100). Split host sector data 106 may be split between a first codeword 105 and a second codeword 107. In this regard, each portion of split host sector data 106 may be included as part of a separate codeword, each codeword having its own error correcting data 108. Accordingly, ECC decoding of codewords retrieved from the flash page can be started before both portions of split host sector data 106 have been retrieved from the flash memory. The decoder does not have to wait for both pages to be read, freeing up buffer space and clock cycles for other operations.

One advantage to the above organization of host data sectors in codewords of a length determined by the equal division of page length includes the simplification of the back end processor in the SSD. The complexity of back end processing is growing as the flash cells become more error prone with shrinking technology. Recovering some data may require multiple reads of the flash page with different read settings. This process is made much more complex if an ECC codeword is split across multiple pages, especially when each page may potentially have very different characteristics. These page differences should be properly handled in the read process and decoder. Furthermore, twice as many read operations may be required to recover these marginal split codewords which places additional requirements on hardware buffers and scheduling.

FIG. 1B depicts a block diagram illustrating an example series of codewords, which substantially fills a page of a memory block according to one aspect of the subject technology. The subject technology generates and provides ECC codewords 101 that substantially fill all of the available storage capacity of a flash memory page when written to the page. In one example, each codeword 101 containing host data and error correction coding, is slightly smaller than codeword 100 by a few bits (for example, 8 bits). As a result, when multiple codewords 101 are written to a flash memory page, there is an unused section 110 that comprises only a few bytes (for example, 2 to 64 bytes). According to the example, if a flash page N comprises only two codewords 101, then unused section 110 is only 16-bit or 2-byte wide. Similarly, if flash page N comprises 8 codewords 100, then the unused section 110 is 8-byte wide. In this regard, after one page has been substantially filled with codewords 101, new codewords 101 are written to a subsequent page (for example, page N+1), rather than overlapping between pages (and/or completely filling the first written page, through section 110).

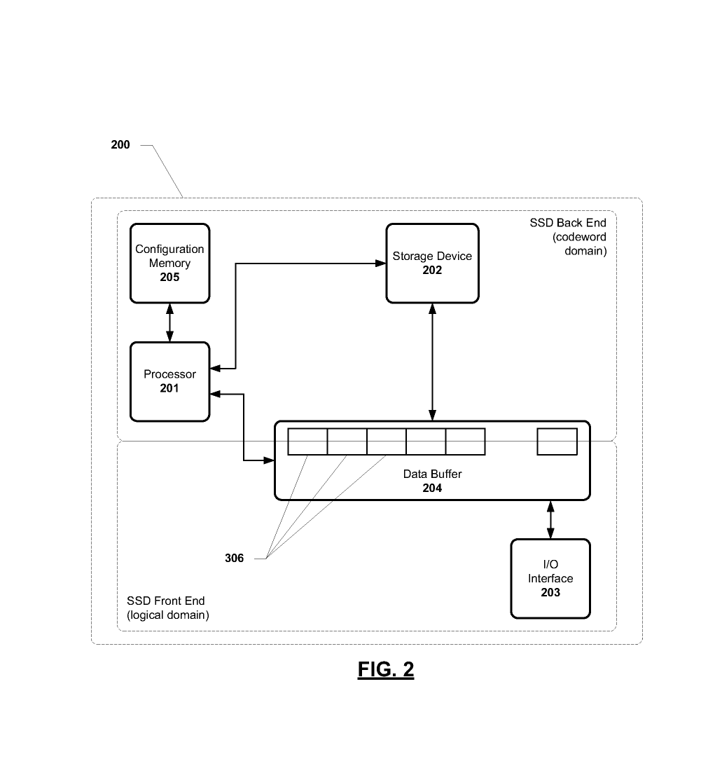

FIG. 2 depicts an example system for mapping data sectors received from a host system to codewords sized for storage on a disparate storage device according to one aspect of the subject technology. Data storage system 200 includes a processor 201 (for example, a data storage or SSD controller, a microprocessor, or the like), one or more storage devices 202 (for example, a flash memory, random-access memory, optical or magnetic media device, or other storage devices used in a data storage system), an input/output (I/O) interface 203, a data buffer 204, and a configuration memory 205.

Data buffer 204 provides a hardware mechanism for facilitating the separation of the SSD front end which interfaces with a host system, and the SSD back end which interfaces with storage devices 202. Data is temporarily stored in data buffer 204 when received for storage via I/O interface 203 from a host system, or when retrieved from storage device 202 for transmission via I/O interface 203 to the host system. When functioning to facilitate storage, data buffer 204 may be partitioned to divide temporarily stored data therein and create appropriately sized data payloads for encoding into codewords for use by the SSD back end. In this manner, the SSD back end is only concerned with encoding data payloads into codewords sized to fit within the page boundaries of storage devices 202, and decoding codewords retrieved from storage devices 202 back into the same sized data payloads. On the other hand, the SSD front end is only concerned with receiving and sending host data units, without regard to how those host data units were, or should be, stored in storage devices 202.

Data buffer 204 may be realized by volatile or non-volatile memory, and may include one or more blocks, pages, or other units of memory. The functionality of data buffer 204 and storage devices 202 may be implemented in the same storage device or distributed across a group of storage devices. Moreover, the storage devices may take any form such as a RAM, flash memory, optical or magnetic media, or the like. In one example, data buffer 204 is a section of memory reserved (for example, dynamically at runtime) within one or more storage devices 202.

Data storage system 200 may include machine-readable media (for example, non-transitory media), including instructions thereon that, when executed, facilitate the transfer of data between I/O interface 203, data buffer 203, and storage device 202, and other methods transmission and/or modification of the data described herein. In one example, data storage system 200 receives a host data unit from a host device. The host data unit may include one or more sectors of data or other units of data sized according to the host device. The host data unit is received into data buffer 204, and data buffer 204 temporarily stores the data payload and facilitates populating one or more codewords of a predetermined length from the data payload. In some aspects, the codeword length may be selected such that the codeword length divides a size of a page of memory (for example, of storage devices 202) by a real number. The codeword length may be selected at runtime or during configuration of data storage system 200 (for example, at the factory).

In the described example, data storage system 200 may populate a first codeword with a first portion of a received host data unit and first error correction data corresponding to the first portion, and populate a second codeword with a second portion of the host data unit and second error correction data corresponding to the second portion. The construction of the codewords may take place in data buffer 204 or a second buffer. Where data buffer 204 is used to populate codewords, space for one or more codewords may be reserved in data buffer 204 based on the codeword length. Where a second buffer is used, data buffer 204 may sequentially store received units of data for processing into codewords at the second buffer.

After the codewords have been populated, the codewords may be written to one or more pages of memory. In some aspects, the codewords (for example, the previously described first and second codewords) may be stored at respective addresses of a memory page, the respective addresses being separated by the previously described codeword length. In one aspect, the codewords may be stored sequentially. The codewords may, for example, be stored so that they evenly fill a page of memory, with none of the codewords being split between two or more pages. The respective addresses at which each codeword are stored may be predetermined, or determined at runtime, based on the codeword length, memory page size, and a starting address of a respective memory page and stored, for example, in configuration memory 205. Configuration memory 205 may include a lookup table, and, before storing or retrieving a codeword from storage device 202, processor 201 may retrieve, from the lookup table, a respective address associated with the codeword.

In the described example, data storage system 200 may read the first codeword from the one or more pages of memory to read the first portion of the host data unit and the first error correction data, and then perform an error correction on the first portion of the host data unit using the first error correction data Likewise, data storage system 200 may read the second codeword from the page of memory to read the second portion of the host data unit and the second error correction data, and then perform an error correction on the second portion of the host data unit using the second error correction data. In this regard, error correction may be performed on the first portion before error correction on the second portion is initiated.

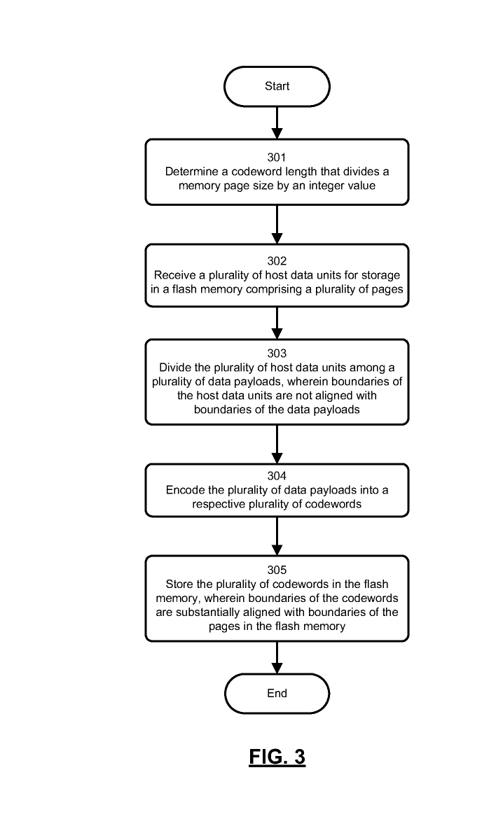

FIG. 3 is a flowchart illustrating an example process for storing data in a flash memory device according to one aspect of the subject technology. According to one aspect, a SSD controller may be configured to map codewords to a memory block. In block 301, a codeword length is determined, such that the codeword length divides a memory page size by an integer value. The codeword length may be determined based on a selected code rate, or by first determining the page size of a storage device 202 and then dividing that page size by a predetermined number (for example, the number of codewords to be stored on each page). In some aspects, determining the codeword length may include determining the page size at runtime, or on a power-up of the storage device. In other aspects, determining the codeword length may include configuring the storage device with a selected codeword length during a factory configuration of the storage device, installation of the storage device within a data storage system 200, or the like.

In block 302, a plurality of host data units (for example, sectors) is received for storage in a flash memory comprising a plurality of pages. Host data units may include one or more sectors of data provided by a host system. A host data unit may be a different size than a codeword into which at least a portion of the host data unit is encoded. The host system may include, for example, a microprocessor, external memory, and/or peripheral components operating in concert with a data storage system that includes the storage device.

In block 303, the plurality of host data units are divided among a plurality of data payloads. In this respect, boundaries of the host data units are not aligned with boundaries of the data payloads. For example, a host data unit may be a data sector of a first size that, when encoded into a codeword, is not suitable for storage in a page of the flash memory without stopping short of filling the whole page or splitting some of the codewords across two pages. On the other hand, a data payload may be sized to, when encoded and stored with other data payloads, evenly fill the page of the flash memory. In this respect, the plurality of host data units received from the host may be divided among the plurality of data payloads for encoding and storing in the flash memory so that space is not wasted and the data may be retrieved without waiting for successive page operations to complete.

In block 304, the plurality of data payloads is encoded into a respective plurality of codewords. Each codeword may be sized to the previously determined codeword length and include at least a portion of a host data unit and corresponding error correction data. In some aspects, a host data unit received from a host may be split between a first data payload and second data payload. Respective error correction data may be generated based on a corresponding data payload. In one example, a host data unit includes a host sector of data. In this regard, one or more codewords may be generated by first generating a data payload from the first sector of data and a first portion of the second sector of data. A first codeword may be generated by encoding the data payload with error correction data corresponding to the data payload. A second codeword may be generated that includes a remaining portion of the second sector of data. In another example, a host data unit may include a sector of data, and a first codeword may be generated by encoding a first portion of the sector of data with error correction data corresponding to the first portion, and a second codeword may be generated that includes a remaining portion of the sector of data.

In block 305, the plurality of codewords are stored in the flash memory wherein boundaries of the codewords are substantially aligned with boundaries of the pages in the flash memory. As described previously, a data payload may be sized to, when encoded and stored with other data payloads, evenly fill a page of the flash memory, without overlapping subsequent pages. In this regard, none of the codewords are split between two or more memory pages of the storage device.

In some aspects, the SSD controller maintains a virtual address of each host data unit stored in the flash memory. When host data is received for storage, the host data units are associated with respective logical addresses. The controller maps respective logical addresses of host data units to virtual addresses of corresponding data codewords into which the host data units were encoded. In this manner, each host data unit may be accounted for among the plurality of data codewords after they are stored. The virtual address of each of the plurality of codewords is then mapped to a physical address in the flash memory. Accordingly, the SSD controller knows the location of each host data unit, even if that host data unit begins at a location within a codeword (for example, at the beginning data position), falls entirely within a single codeword, crosses codeword boundaries, or even crosses flash page boundaries. In one example, the mapping of the logical address includes an offset value for each of the first virtual addresses so that a host data unit may be indexed and retrieved from one or more data payloads encoded into a single codeword or between multiple codewords.

Similarly, the SSD controller may store the one or more codewords at respective offset addresses, the offset addresses being based on the codeword length, memory page size, and a starting address of a memory page. Accordingly, storing the codewords in the storage device may include retrieving, from a lookup table, a respective offset address associated with a memory page of the storage device, and storing a respective codeword at the respective offset address.

In a further example, the previously described first and second codewords may be read from the memory device. Reading a host data unit may include retrieving, from the lookup table, the offset address of the codeword and offset address within the codeword of the host data unit. In one example, a first portion of host data may be generated by decoding the first codeword based on error correction data of the first codeword, and a second portion of host data generated by decoding the second codeword based on error correction data of the second codeword. The sector of data may be generated by assembling the first portion and the second portion. The sector of data may then be provided to the host device. In this aspect, a decoder may begin decoding the first portion of host data before decoding of the second portion is initiated.

With further reference to FIG. 2, processor 201 may function as a SSD controller. processor 201 may use configuration memory 205 for temporary storage of data and information used to manage data storage system 200. Processor 201 may include several internal components (not shown) such as a read-only memory, a flash component interface (for example, a multiplexer to manage instruction and data transport along a serial connection to storage devices 202), an I/O interface, error correction circuitry, and the like. In some aspects, all of these elements of controller 201 may be integrated into a single chip. In other aspects, these elements may be separated on their own PC board.

Processor 201 may also be configured to execute code or instructions to perform the operations and functionality described herein, manage request flow and address mappings, and to perform calculations and generate commands. Processor 201 is configured to monitor and control the operation of the components of system 200. The processor may be a general-purpose microprocessor, a microcontroller, a digital signal processor (DSP), an application specific integrated circuit (ASIC), a field programmable gate array (FPGA), a programmable logic device (PLD), a controller, a state machine, gated logic, discrete hardware components, or a combination of the foregoing. One or more sequences of instructions may be stored as firmware on ROM within processor 201 and/or its processor. One or more sequences of instructions may be software stored and read from storage medium 205, flash memory 202, or received from a host device (for example, via I/O interface 203). ROM, storage medium 205, flash memory 202, represent examples of machine or computer readable media (for example, non-transitory media) on which instructions/code executable by processor 201 and/or its processor may be stored. Machine or computer readable media may generally refer to any medium or media used to provide instructions to processor 201 and/or its processor, including both volatile media, such as dynamic memory used for storage media 205 or for buffers within processor 201, and non-volatile media, such as electronic media, optical media, and magnetic media.

In some aspects, storage devices 202 include flash memory. Processor 201 is configured to store, in flash memory 202, data received from a host device (for example, the previously described host sector data) in response to a write command from the host device. Processor 201 is further configured to read data stored in flash memory 202 and to transfer the read data to the host device in response to a read command from the host device. A host device may be any device configured to be coupled to data storage system 200 via I/O interface 203 and to store data in data storage system 200. The host device may be a computing system such as a personal computer, a server, a workstation, a laptop computer, PDA, smart phone, and the like. Alternatively, a host device may be an electronic device such as a digital camera, a digital audio player, a digital video recorder, and the like.

In some aspects, configuration memory is a storage medium. In this regard, storage medium 205 represents volatile memory used to temporarily store data and information used to manage data storage system 200. According to one aspect of the subject technology, storage medium 205 is random access memory (RAM) such as double data rate (DDR) RAM. Other types of RAM also may be used to implement storage medium 205. Memory 205 may be implemented using a single RAM module or multiple RAM modules. While storage medium 205 is depicted as being distinct from processor 201, those skilled in the art will recognize that storage medium 205 may be incorporated into processor 201 without departing from the scope of the subject technology. Alternatively, storage medium 205 may be a non-volatile memory such as a magnetic disk, flash memory, peripheral SSD, and the like.

As further depicted in FIG. 1, data storage system 200 may also include I/O interface 203 (for example, a host interface). I/O interface 203 is configured to be coupled to a host device, to receive data from the host device and to send data to the host device. I/O interface 203 may include both electrical and physical connections for operably coupling the host device to processor 201, for example, via the I/O interface of processor 201. I/O interface 203 is configured to communicate data, addresses, and control signals between a host device and processor 201. Alternatively, the I/O interface of processor 201 may include and/or be combined with I/O interface 203. I/O interface 203 may be configured to implement a standard interface, such as Serial-Attached SCSI (SAS), Fiber Channel interface, PCI Express (PCIe), SATA, USB, and the like. I/O interface 203 may be configured to implement only one interface. Alternatively, I/O interface 203 (and/or the I/O interface of processor 201) may be configured to implement multiple interfaces, which are individually selectable using a configuration parameter selected by a user or programmed at the time of assembly. I/O interface 203 may include one or more buffers for buffering transmissions between a host device and processor 201.

Flash memory 202 represents a non-volatile memory device (for example, one or more storage devices 202) for storing data (for example, the previously described host sector data). According to one aspect of the subject technology, flash memory 202 includes, for example, a NAND flash memory. Flash memory 202 may include a single flash memory device or chip, or, as depicted by FIG. 1, may include multiple flash memory devices or chips arranged in multiple channels. Flash memory 202 is not limited to any particular capacity or configuration. For example, the number of physical blocks, the number of physical pages per physical block, the number of sectors per physical page, and the size of the sectors may vary within the scope of the subject technology.

Flash memory may have a standard interface specification. This standard ensures that chips from multiple manufacturers can be used interchangeably (at least to a large degree). The interface hides the inner working of the flash memory and returns only internally detected bit values for data. In one aspect, the interface of flash memory 202 is used to access one or more internal registers and an internal flash controller for communication by external devices. In some aspects, the registers may include address, command, and/or data registers, which internally retrieve and output the necessary data to and from a NAND memory cell array. For example, a data register may include data to be stored in the memory array, or data after a fetch from the memory array, and may also be used for temporary data storage and/or act like a buffer. An address register may store the memory address from which data will be fetched to the host system or the address to which data will be sent and stored. In some aspects, a command register is included to control parity, interrupt control, and the like. In some aspects, the internal flash controller is accessible via a control register to control the general behavior of flash memory 202. The internal flash controller and/or the control register may control the number of stop bits, word length, receiver clock source, and may also control switching the addressing mode, paging control, coprocessor control, and the like.

In some aspects, the registers may also include a test register. The test register may be accessed by specific addresses and/or data combinations provided at the interface of flash memory 202 (for example, by specialized software provided by the manufacturer to perform various tests on the internal components of the flash memory). In further aspects, the test register may be used to access and/or modify other internal registers, for example the command and/or control registers. In some aspects, test modes accessible via the test register may be used to input or modify certain programming conditions of flash memory 202 (for example, erase parameters) to dynamically vary how data is from the memory cells of the memory arrays.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A method for storing data in a solid-state device, the method comprising:
receiving a plurality of host data units for storage in a flash memory comprising a plurality of pages;
dividing the plurality of host data units among a plurality of data payloads, wherein boundaries of the host data units are not aligned with boundaries of the data payloads;
encoding the plurality of data payloads into a respective plurality of codewords; and
storing the plurality of codewords in the flash memory, wherein boundaries of the codewords are substantially aligned with boundaries of the pages in the flash memory.

2. The method of claim 1, further comprising:
mapping a logical address of each of the plurality of host data units to a virtual address of one or more of the plurality of data payloads; and
mapping a virtual address of each of the plurality of codewords to a physical address in the flash memory.

3. The method of claim 2, wherein dividing the plurality of host data units comprises splitting at least one of the host data units between two of the data payloads, and
wherein the logical address of the at least one host data unit is mapped to the virtual addresses of the two data payloads.

4. The method of claim 3, wherein the mapping of the logical address includes an offset value for each of the virtual addresses.

5. The method of claim 4, wherein the offset value is based on a codeword length, memory page size.

6. The method of claim 1, wherein storing the plurality of codewords in the flash memory comprises storing two or more codewords in one page in the flash memory.

7. The method of claim 1, wherein the boundaries of the codewords are aligned with boundaries of the pages in the flash memory.

8. The method of claim 7, wherein each of the plurality of codewords is of a predetermined data length that divides a data length of each of the pages in the flash memory by an integer value.

9. The method of claim 1, wherein dividing the plurality of host data units among the plurality of data payloads comprises allocating a predetermined amount of data from the host data units to each of the data payloads.

10. The method of claim 1, wherein dividing the plurality of host data units among the plurality of data payloads comprises generating a data payload from two or more host data units.

11. The method of claim 1, further comprising:
reading a first codeword and a second codeword from the flash memory;
generating a first portion of host data by decoding the first codeword;
generating a second portion of host data by decoding the second codeword;
generating a host data unit from the first portion and the second portion; and
providing the host data unit to the host device.

12. The method of claim 11, wherein a decoder begins decoding the first portion of host data before decoding of the second portion is initiated.

13. A system, comprising:
one or more memory units;
one or more data buffers configured to receive, for storage in a flash memory, host data units from host computing system;
a controller configured to:
divide a plurality of received host data units among a plurality of data payloads, wherein boundaries of the host data units are not aligned with boundaries of the data payloads;
facilitate encoding the plurality of data payloads into a respective plurality of codewords; and
store the plurality of codewords in the flash memory, wherein boundaries of the codewords are substantially aligned with boundaries of pages in the flash memory.

14. The system of claim 13, wherein boundaries of the codewords are aligned with boundaries of pages in the flash memory.

15. The system of claim 14, wherein each of the plurality of codewords is of a predetermined data length that divides a data length of each of the pages in the flash memory by an integer value.

16. The system of claim 13, wherein dividing the plurality of host data units among the plurality of data payloads comprises allocating a predetermined amount of data from the host data units to each of the data payloads.

17. The system of claim 13, wherein the controller is further configured to:
facilitate mapping a logical address of each of the plurality of host data units to a virtual address of one or more of the plurality of data payloads; and
map each of virtual addresses of the plurality of codewords to a physical address in the flash memory.

18. The system of claim 17, wherein the controller being configured to divide the plurality of host data units comprises the controller being configured to split at least one of the host data units between two of the data payloads, and
wherein, on the at least one host data unit being split, the controller is configured to map the logical address of the at least one host data unit to the virtual addresses of the two data payloads.

19. The system of claim 18, wherein, on the at least one host data unit being split, the controller is configured to provide an offset value for each of the virtual addresses.

20. The system of claim 13, wherein the controller is further configured to:
read a first codeword and a second codeword from the one or more memory units.
facilitate decoding the first and second codewords to produce a first data unit and a second data unit;
generate a host data sector that includes the first data unit and at least a portion of the second data unit;
provide the host data sector to the host computing system.

21. The system of claim 20, wherein a decoder begins decoding the first portion of host data before decoding of the second portion is initiated.

22. A machine-readable media including instructions thereon that, when executed, perform a method, the method comprising:
receiving, into a data buffer, a plurality of host data units for storage in a flash memory comprising a plurality of pages;
distributing the plurality of host data units among a plurality of data payloads, wherein boundaries of the host data units are not aligned with boundaries of the data payloads;
facilitating encoding the plurality of data payloads into a respective plurality of codewords; and
storing the plurality of codewords in the flash memory, wherein boundaries of the codewords are substantially aligned with boundaries of the pages in the flash memory.
